(19) United States
(12) Patent Application Publication
(10) Pub. No.: US 2016/0231819 A1
(43) Pub. Date: Aug. 11, 2016

(54) WEARABLE SYSTEM INPUT DEVICE

(71) Applicant: Avaya Inc., Santa Clara, CA (US)

(72) Inventor: David L. Chavez, Broomfield, CO (US)

(21) Appl. No.: 14/619,815

(22) Filed: Feb. 11, 2015

(51) Int. Cl. G06F 3/01; G06F 3/0346; G06F 3/16; G06F 3/044

(52) U.S. Cl. CPC G06F 3/017; G06F 3/016; G06F 3/044; G06F 3/0346; G06F 3/167; G06F 2203/04104; G06F 2203/04105

(57) ABSTRACT

Methods, devices, and systems are provided that enable a user to discreetly provide input to a computer system via a handheld input control device. The input control device is physically discrete, or separate, from the computer and is configured to provide input based on one or more of an orientation of the device and a disposition of a user's digits on the device. The device can continually and dynamically reconfigure itself based on a recognizable pattern, or locational arrangement, associated with a user's hand. For example, the device can determine where the features of a user's hand are, on or about the device, at any point in time. The device can then map, or remap, various input sensors to match the locational arrangement of features in an ad hoc manner when the device is grasped.

### FIELD OF THE DISCLOSURE

The present disclosure is generally directed toward input devices and more specifically toward input devices for wearable computers and peripherals.

### BACKGROUND

Today, wearable computers and controls are changing the way that users interact with devices and with the world. Some examples of wearable computer systems include the Eurotech Zypad, Google Glass, Hitachi Poma, Vuzix iWear VR920 & 1200, and the Brother AiRScouter, to name a few. Most wearable computer systems include a power supply, processor, memory, storage, an output (e.g., audio, video, tactile, etc.), and provide for one or more human input options. While some elegant solutions exist for the wearable computer, current input options for the wearable computer are based on non-wearable-computer technology. In other words, typical input options for wearable computers are based on tablet, laptop, and/or desktop computer systems. These input options allow a user to provide input to the wearable computer via a keyboard and/or mouse, touchpad, microphone and/or transducer (e.g., for voice commands, etc.), and combinations thereof.

Because these input options are based on non-wearable-computer technology, the input devices that are associated with these options can be bulky, awkward, intrusive, public, and may require physical connection to the user and/or the wearable computer. As can be appreciated the wearable computers and controls should be comfortable, simple to operate, sophisticated, mobile, able to multi-task, include integrated features, include a heads-up display, cause a minimum of side effects, and enhance the perceived quality of life of the user. Despite intense competition and investment, market adoption has been weak because the requirements are not being met in a way that will create mass appeal.

Previous attempts to improve input devices for wearable computers have been based on reducing the size of the input devices. Simply reducing the size of old technology input devices does not provide new control technologies that allow for easy control of wearable computers.

Moreover, current input devices and methods are not inherently private. For instance, a user providing voice commands to a wearable computer system (via a microphone or other audio input device) allows those who are near the user to hear everything the user speaks. As another example, the keystrokes or movements provided by users typing on a keyboard or touchpad, whether virtual or physical, can be visually detected and/or recorded. In either case, a user cannot discreetly provide input to the wearable computer, undetected, using these traditional input devices.

### SUMMARY

To be successful, wearable computers and controls need to be comfortable, simple to operate, sophisticated, mobile, able to multi-task, include integrated features, include a heads-up display, cause a minimum of side effects, and enhance the perceived quality of life of the user. Despite intense competition and investment, market adoption has traditionally been weak because these requirements were not being met in a way that created mass appeal.

New inventions should improve on the ideas of a typical physical or virtual keyboard, augmented lens, keyboard projection, or a device requiring that a user's hands are positioned out in front of the user. Significant advances can be made when users can be untethered while retaining mobile computing and telephony capabilities and when privacy concerns are addressed. The proposed embodiments solve these and other issues by providing a small and potentially private device that delivers seamless autonomy and control to a user of the wearable computer.

It is with respect to the above issues and other problems that the embodiments presented herein were contemplated. Among other things, the present disclosure provides methods, devices, and systems that enable a user to discreetly provide input to a computer via a handheld input control device that is physically discrete, or separate, from a wearable computer. In one embodiment, the input control device is not physically connected to any part of the wearable computer system. The input control device may be configured to communicate with the wearable computer system via one or more wireless communications protocols.

In some embodiments, an egg-shaped, or ovoid, input control device is provided that can measure pressure points with an accelerometer and a tactile effects layout. The input control device can be one device available for either hand and/or two devices available for both hands. In one embodiment, the input control device may be specially designed for use by a left and/or right hand of a user. The input control device can be controlled via an orientation of hands and fingers where the user can determine layout and selection of display. The input can be done tactilely without a user's hands leaving the user's pocket. Feedback may be privately provided to the wearer via video and audio means through a heads-up display of the wearable computer and also to/from the device itself via vibration or other physical notification. In one embodiment, the input control device does not have to be attached to the hand, fingers, wrist, or other part of a user. Additionally or alternatively, the input control device may be configured to be active only when the device is held by a user.

The functions of the input control device may include keyboard character selection which can be projected or augmented. In one embodiment, the present disclosure differs from automated controls for gaming like a joystick, steering wheel, etc. which can be difficult to use with a wearable system. For example, embodiments of the input control device may provide individual digit articulation that is “freeform” rather than “bulk” in manipulation.

In one embodiment, orientation of the input control device can be based on detection of the pressure of the palm on the device versus pressure of the digits. In another embodiment, orientation of the input control device may be based on detection of the pressure of the palm of a user and sensor information (e.g., accelerometer, gyroscope, other orientation sensor, and/or the like). The primary method of providing input to the input control device can be a change of pressure of one or more digits on or about the device. Additionally or alternatively, this input may be augmented by slight movement of any digit on the device and/or by twisting of the wrist to spatially reorient the device. In any event, the input may be provided while the input control device is hidden from view (e.g., in a user's pocket, under a table, etc.).

The input control device may be configured to provide feedback to a user. This feedback may correspond to input provided, a state of the input control device, an operation of the input control device, etc., and combinations thereof. Feedback to the user may be provided in visual form via a private screen. This feedback may include, but is not limited to, keyboard layout, text created, text options based on present pressure on the device by the digits and anticipated variants, virtual 3D projection in the private screen of the device and control/key mapping, and audio feedback indicating the type of keys selected and confirmed by input analysis software.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of an embodiment of an input control device in communication with a computer system;

FIG. 2A is a perspective view of an input control device in accordance with embodiments of the present disclosure;

FIG. 2B is a cross-sectional view of the input control device of FIG. 2A taken along line A-A;

FIG. 2C is a perspective view of a first embodiment of an input control device;

FIG. 2D is a perspective view of a second embodiment of an input control device;

FIG. 2E is a perspective view of a third embodiment of an input control device;

FIG. 2F is a perspective view of a fourth embodiment of an input control device;

FIG. 3A is a diagram showing a two-handed operating state of an input control device in accordance with embodiments of the present disclosure;

FIG. 3B is a diagram showing a single-handed operating state of an input control device in accordance with embodiments of the present disclosure;

FIG. 4A is a diagram showing a first control orientation of an input control device in accordance with embodiments of the present disclosure;

FIG. 4B is a diagram showing a second control orientation of an input control device in accordance with embodiments of the present disclosure;

FIG. 4C is a diagram showing a third control orientation of an input control device in accordance with embodiments of the present disclosure;

FIG. 4D is a diagram showing a fourth control orientation of an input control device in accordance with embodiments of the present disclosure;

FIG. 4E is a diagram showing a fifth control orientation of an input control device in accordance with embodiments of the present disclosure;

FIG. 5A is a diagram showing a first control contact pattern on an input control device in accordance with embodiments of the present disclosure;

FIG. 5B is a diagram showing a second control contact pattern on an input control device in accordance with embodiments of the present disclosure;

FIG. 5C is a diagram showing a third control contact pattern on an input control device in accordance with embodiments of the present disclosure;

FIG. 5D is a diagram showing a fourth control contact pattern on an input control device in accordance with embodiments of the present disclosure;

FIG. 6 is a flow or process diagram depicting a method for controlling an input control device in accordance with embodiments of the present disclosure;

FIG. 7 is a flow or process diagram depicting a method of dynamically configuring input conditions for an input control device in accordance with embodiments of the present disclosure;

FIG. 8 is a diagram showing a user interface control environment in accordance with embodiments of the present disclosure;

FIG. 9A is a diagram showing a first embodiment of a virtual input interface in accordance with embodiments of the present disclosure; and

FIG. 9B is a diagram showing a second embodiment of a virtual input interface in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

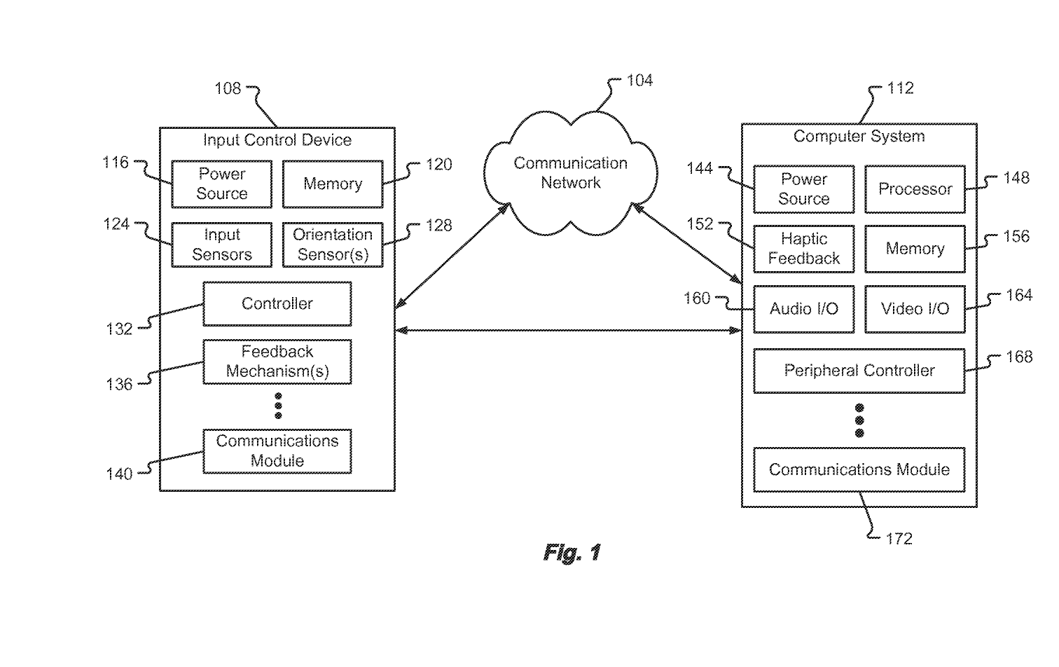

FIG. 1 shows an illustrative embodiment of an input control device 108 in communication with a computer system 112. The input control device 108 may be configured to communicate directly with the computer system 112 using at least one wireless communications protocol. In some embodiments, the input control device 108 may communicate with the computer system 112 across a communication network 104. Communication may include transmitting, receiving, and/or exchanging information between the device 108 and the computer system 112. By way of example, the communication may include one or more control instructions provided by the input control device 108. As another example, the communication may include connection, or “handshake,” information for the device 108 and/or computer system 112. In yet another example, the communication may include feedback information sent from the computer system 112 to the input control device 108, or vice versa.

In accordance with at least some embodiments of the present disclosure, the communication network 104 may comprise any type of known communication medium or collection of communication media and may use any type of protocols to transport messages and/or data between endpoints. The communication network 104 may include wired and/or wireless communication technologies. It can be appreciated that the communication network 104 need not be limited to any one network type, and instead may be comprised of a number of different networks and/or network types. Moreover, the communication network 104 may include a collection of communication components capable of one or more of transmitting, relaying, interconnecting, controlling, or otherwise manipulating information or data from at least one transmitter to at least one receiver. Wireless communications may include information transmitted and received via one radio frequency (RF), infrared (IR), microwave, Wi-Fi, combinations thereof, and the like.

In any event, communications between the input control device 108 and the computer system 112 may be enabled via one or more wireless communications protocols. Examples of wireless communications protocols include, but are in no way limited to, Bluetooth® wireless technology, 802.11x (e.g., 802.11G/802.11N/802.11AC, or the like) wireless standards, etc.

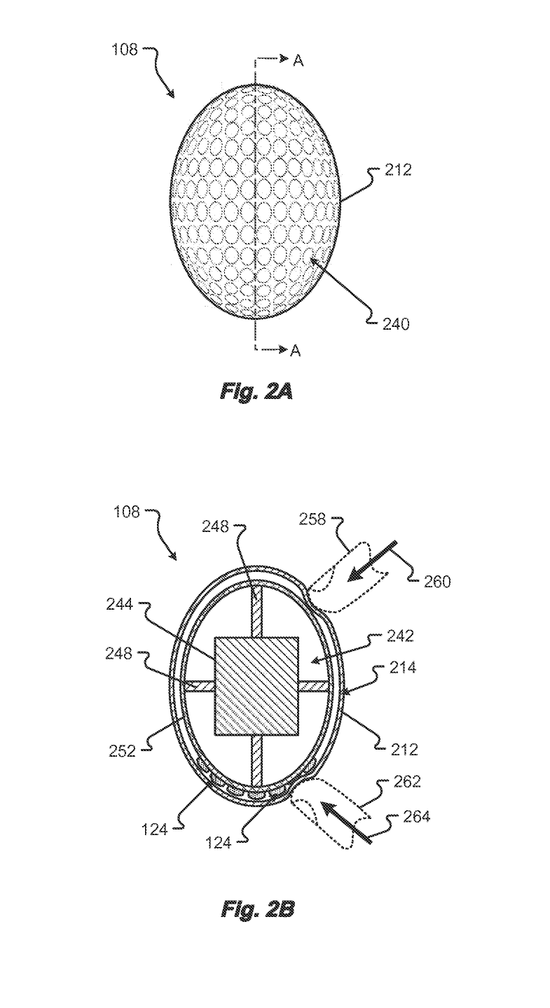

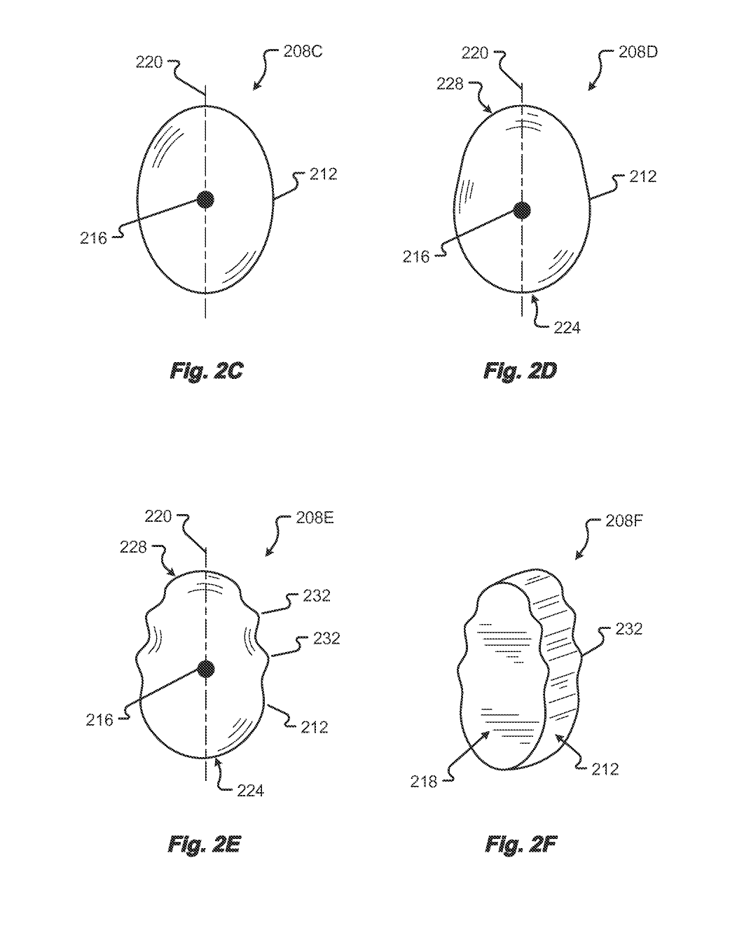

The input control device 108 may comprise a number of operational components including a power source 116, memory 120, input sensors 124, orientation sensors 128, a controller 132, a feedback mechanism 136, a communications module, and more. In some embodiments, one or more of these components may be contained within at least one housing, or shell, of the input control device 108. Additional details regarding the physical structure, shape, appearance, and the arrangement of one or more of the components of the input control device 108 are disclosed in conjunction with FIGS. 2A-7.

The power source 116 may include any type of power source, including, but not limited to, batteries, capacitive energy storage cells, solar cell arrays, etc. One or more components, or modules, may also be included to control the power source 116 or change the characteristics of the provided power signal. Such modules can include one or more of, but is not limited to, power regulators, power filters, alternating current (AC) to direct current (DC) converters, DC to AC converters, receptacles, wiring, other converters, etc. The power source 116 functions to at least provide the input control device 108 with power.

The input control device 108 may also include memory 120 for use in connection with the execution of application programming or instructions by the controller 132, and for the temporary or long term storage of program instructions and/or data. For instance, the memory 120 may comprise RAM, DRAM, SDRAM, or other solid state memory. In some embodiments, the memory 120 may include any module for storing, retrieving, and/or managing data in one or more data stores and/or databases. The database or data stores may reside in the memory 120 of the input control device 108. Additionally or alternatively, the memory 120 may be configured to store data received via one or more of the sensors 124, 128.

The input sensors 124 may include one or more sensors, switches, and/or touch-sensitive surfaces configured to receive input from a user of the input control device 108. Examples of these input sensors 124 can include, without limitation, one or more pressure sensor, piezoelectric sensor or transducer, capacitive sensor, potentiometric transducer, inductive pressure transducer, strain gauge, displacement transducer, resistive touch surface, capacitive touch surface, image sensor, camera, temperature sensor, IR sensor, and the like. In one embodiment, a number of input sensors 124 may be disposed in, on, or about the input control device 108 in an arrangement configured to receive input from any number of areas of the device 108. For example, the input control device 108 may comprise an outer surface. In some cases the outer surface may substantially cover the device 108 or a portion of the device 108. The input sensors 124 may be distributed around a core of the input control device 108 such that a user contacting the outer surface of the device 108 can access input sensors 124 in any orientation, position, or relationship of the device in the user's hand or hands. In one embodiment, the input sensors 124 may be substantially evenly distributed about the input control device 108 such that the device 108 can receive input at any contact area along the periphery of the device 108.

In one embodiment, the input sensors 124 may be configured to determine a contact pressure of a user handling the input control device 108. The contact pressure may correspond to the contact pressure provided by one or more of a user's digits, palm, extremity, or other appendage or body part. In some embodiments, the user's digits may include fingers, thumbs, toes, or other projecting part of a body, etc. In any event, the contact pressure may be measured or determined based on input received via the input sensors 124. As one example, an input control device 108 having a compliant outer surface and displacement measurement input sensors contained within the outer surface can measure the displacement of the outer surface at a contact point, or area, as a particular input type. As another example, where an outer surface of the input control device 108 is a touch surface (e.g., resistive or capacitive, etc.), the pressure of a user's touch on the touch surface may cause a change to the electrical charge or field in a particular region of the surface having specific coordinates. In this example, the magnitude of the change of the electrical charge or field may correspond to a magnitude of the pressure exerted on the touch surface. As yet another example, the pressure be determined by detecting (e.g., via image sensors, temperature sensors, etc.) a first size of the contact area of a user's digits, or other body part, on the outer surface of the input control device 108 and a subsequent size of the contact area of the user's digits, or other body part, on the outer surface of the device 108. For instance, as the contact pressure of the user's digits increases, the size of the contact area increases. As the contact pressure of the user's digits decreases, the size of the contact area decreases. This change in contact area size may correspond to a magnitude of the pressure exerted on the device 108. In some embodiments, one or more of the input sensors 124 may be configured without assigned functions, dynamically configured with functions to suit a user's contact pattern or locational arrangement of features, assigned to receive user input from one or more input entities in a particular locational arrangement, assigned to ignore input from specific sensors, contact areas, or non-contact areas, combinations thereof, and the like. By way of example, the input sensors 124 may have an unassigned input functionality until a user contacts the input control device 108 and the controller 132 assigns input functions to the input sensors contacted by or adjacent to the user's hand.

The orientation sensors 128 can include at least one of an accelerometer, gyroscope, geomagnetic sensor, other acceleration sensor, magnetometer, and the like. Among other things, the orientation sensors 128 may determine an orientation of the input control device 108 relative to at least one reference point. For example, the orientation sensors 128 may detect an orientation of the input control device 108 relative to a gravity vector. Additionally or alternatively, the orientation sensors 128 may detect a change in position of the input control device 108 from a first position to a second position, and so on. Detected orientations may include, but are in no way limited to, tipping, tilting, rotating, translating, dropping, spinning, shaking, and/or otherwise moving the input control device 108. As described herein, various orientations, alone or in combination with a contact pattern detected by the input sensors 124, may correspond to control instructions. These control instructions may be context sensitive instructions, mapped instruction sets, and/or rule-based instructions. The control instructions may be provided to a computer system via the communications module 140.

In some embodiments, the controller 132 may comprise a processor or controller for executing application programming or instructions. In one embodiment, the controller 132 may include multiple processor cores, and/or implement multiple virtual processors. Additionally or alternatively, the controller 132 may include multiple physical processors. For example, the controller 132 may comprise a specially configured application specific integrated circuit (ASIC) or other integrated circuit, a digital signal processor, a controller, a hardwired electronic or logic circuit, a programmable logic device or gate array, a special purpose computer, or the like. The controller 132 generally functions to run programming code or instructions implementing various functions of the input control device 108.

The input control device 108 may include one or more feedback mechanisms 136. Feedback mechanisms 136 can include any number of features or components that are configured to provide feedback to a user of the device 108. In some embodiments, feedback may be provided audibly, visually, and/or mechanically. Audible feedback can be provided by a speaker, sound transducer, or other sound emitting device. Visual feedback can be provided via one or more lights, displays, etc. Mechanical feedback can be provided via a tactile transducer, vibration motor, actuator, and/or the like. In some embodiments, at least one feedback mechanism 136 may be used to identify a state of the device 108 and/or computer system 112, indicate an operational condition of the device 108 and/or computer system 112, identify a selection made via the device, identify a control instruction, and/or other information associated with the device 108 and/or computer system 112.

The communications module 140 may be configured to exchange messages and/or other data between the input control device 108 and the computer system 112. In some embodiments, input detected by the input sensors 124 of the device 108 may be interpreted by the controller 132 and sent to the computer system 112 via the communications module 140. Communications may be exchanged and/or transmitted using any number wireless communications protocols.

In some embodiments, the computer system 112 may comprise a power source 144, a processor 148, a haptic feedback device 152, memory 156, audio input/output (I/O) device 160, video I/O device 164, at least one peripheral, or interface device, controller 168, and a communications module 172. While a number of these components may be similar, if not identical, to the components previously described, each of the components can be associated with the computer system 112. In accordance with embodiments of the present disclosure, the computer system 112 may be arranged as a “wearable” combination of components. The wearable computer system 112 may include a number of the components in a self-contained unit that may be portably worn by an operator, or user, of the computer system 112.

The haptic feedback device 152 may be configured to provide mechanical feedback to a user of the computer system 112. This feedback may be provided via a tactile transducer, vibration motor, actuator, and/or the like.

The audio I/O device 160 may be configured to provide audible output to a user of the system 112 via one or more speakers, sound transducers, or other sound emitting devices. In some embodiments, control instructions provided via the input control device 108 can be interpreted by the peripheral controller 168 of the system 112 and audible output may be provided to the user via the audio I/O device 160. For example, the computer system 112 may output an audible signal via the audio I/O device 160 indicating a position of an interface element relative to navigable and/or selectable content available to the user. As the user provides navigation and/or selection input via the input control device 108, the audible signal may change to indicate a change in the position of the interface element and/or list selectable content coinciding with the position of the interface element.

The video I/O device 164 may be configured to provide visual output to a user of the system 112 via one or more lights and displays (e.g., a physical screen configured to display output from the computer system 112 to a user, etc.). In some embodiments, control instructions provided via the input control device 108 may be interpreted by the peripheral controller 168 of the system 112 and visual output may be provided to the user via the video I/O device 164. For instance, the computer system 112 may render a menu to a display of the video I/O. In some cases, the computer system 112 may render an interface element configured to move about the rendered content on the display (e.g., a pointer or cursor in an application, etc.). Input provided via the input control device 108 (e.g., contact patterns and/or orientation, etc.) may control a navigation of the interface element about the rendered menu and/or a selection of menu options rendered to the display.

FIGS. 2A-F show views of various embodiments of an input control device 108. The input control device 108 may be configured to be operable using one hand, two hands, or combinations thereof. In some embodiments, the input control device 108 may be configured to be held and/or operated by a specific hand (e.g., right-handed, left-handed, etc.). In other embodiments, the input control device 108 may be configured to be held and/or operated by either hand (e.g., universal or ambidextrous). One or more input control device 108 may be used to provide additional functionality and/or interface capabilities with the computer system 112. For example, a first input control device 108 may be operated by a user's right hand, while a second input control device 108 may be operated by a user's left hand. In a gaming example, each input control devices 108 may be associated with unique sets of control functions. Continuing this example, a first set of control functions associated with the first input control device 108 may be tied to steering/navigating a craft, while the second set of control functions associated with the second input control device 108 may be tied to controlling acceleration of the craft. In the case of a 3D modeling/viewing application, a first set of control functions associated with the first input control device 108 may be tied to rotating a 3D model, while the second set of control functions associated with the second input control device 108 may be tied to controlling the zoom level of the model view. As another example, the first input control device 108 may be associated with “mouse” navigation/selection functions, while the second input control device 108 may be associated with “keyboard” functions, or vice versa. In any event, the input control devices 108 may be operated simultaneously to provide a particular unique combined output or individual output. The output can be interpreted by one or more components of the computer system 112 or the input control device 108.

Referring now to FIGS. 2A and 2B, each input control device 108 includes at least one contact surface 212 and a plurality of input sensor contact areas 240. The contact surface 212 may be configured as an arcuate and/or nonplanar surface. As shown in FIG. 2A, a number of input sensor contact areas 240 may be distributed around the contact surface 212 of the input control device 108. The contact areas 240 may correspond to the sensing regions of the input control device 108. In one embodiment, the contact areas 240 may be identified by substantially circular or elliptical rings. These rings may correspond to one or more of identification marks, indentations, dimples, raised domes, bumps, or protrusions, disposed at least partially on the contact surface 212, and the like. In any event, one or more input sensors 124 may be associated with each contact area 240 or group of contact areas 240.

FIG. 2B shows a cross-sectional view of the input control device 108 of FIG. 2A taken along line A-A. The components of the input control device 108 may be arranged within the contact layer 214 of the input control device 108 in an internal volume 242. In one embodiment, the components may be attached to a mount substrate 244. Examples of mount substrates 244 can include, but are not limited to, printed circuit boards, plastic housings, metal housings, cast material, molded material, laminated materials, fastened materials, and the like. The mount substrate 244 may be suspended and/or supported in the input control device 108 via one or more support members 248 extending from the mount substrate 244 to a housing 252. The housing 252 may include one or more surfaces that contact the contact layer 214 of the device 108. In some embodiments, the input sensors 124 may be disposed in a pattern around the housing 252. The housing 252 may be configured as a rigid shell having one or more features configured to receive the input sensors 124 or a sensing surface.

Although shown as a single layer, the contact layer 214 may include multiple sublayers or strata. In one embodiment, the contact layer 214 may be configured with one or materials providing compliance, semi-compliance, and/or variable compliance when subjected to contact pressure. By way of example, as pressure is applied to the contact surface 212 via a first digit 258 in a first direction 260 toward the internal volume 242 of the device 108, the contact layer 214 generally complies until an input is detected via the input sensors. As shown, the contact pressure applied by the first digit may be detected by a resistive touch surface when the contact layer is moved into contact with a resistive touch surface disposed adjacent to the housing 252. As another example, as pressure is applied to the contact surface 212 via a second digit 262 in a second direction 264 toward the internal volume 242 of the device 108, the contact layer 214 generally complies until an input sensor 124 is actuated. In some embodiments, the input control device 108 may include single or multiple types of input sensors 124. For instance, mechanical input sensors (e.g., pressure sensors, switches, displacement sensors, etc.) may be used to activate the device 108 while electrical input sensors (e.g., touch surfaces, etc.) may be used to provide control instruction input.

The input control device 108 may be configured in a number of shapes and sizes. FIGS. 2C-F show illustrative examples of various input control device shapes and features. Although a number of shapes are shown, it should be appreciated that the components and/or features associated with the input control device 108 should not be limited to these illustrative shapes. As can be appreciated, the input control device 108 employ any three-dimensional shape. In some embodiments, input may be provided by exerting a force on the contact surface 212 of the input control device 108 toward the centroid 216, or geometric center, of the device 108. Additionally or alternatively, input may be provided by orienting the input control device 108 relative to a reference point (e.g., gravity vector, first position, etc.).

FIG. 2C shows a perspective view of an ellipsoid-shaped input control device 208C. In some embodiments the ellipsoid-shaped input control device 208C may be substantially symmetrical about a central axis 220. The ellipsoid-shaped input control device 208C may include at least one contact surface 212 and a centroid 216, or geometric center.

FIG. 2D shows a perspective view of an ovoid-shaped input control device 208D. In some embodiments the ovoid-shaped input control device 208D may be substantially symmetrical about the central axis 220. The ovoid-shaped input control device 208D may include at least one contact surface 212 and a centroid 216, or geometric center.

FIG. 2E shows a perspective view of an ovoid-shaped input control device 208E having a number of raised portions 232 (e.g., domes, ridges, cones, combinations thereof, etc.) disposed along various points and areas of the contact surface 212. These raised portions may correspond to an ergonomic arrangement suited to fit a user's hand. In some embodiments the ovoid-shaped input control device 208E having a number of raised portions 232 may be substantially symmetrical about the central axis 220. The ovoid-shaped input control device 208E having a number of raised portions 232 may include at least one contact surface 212 and a centroid 216, or geometric center.

In some embodiments, the input control device 108 may not be entirely symmetrical about the central axis 220. For instance, FIG. 2F shows a flattened ovoid-shaped input control device 208F similar to the ovoid-shaped input control device 208E described in conjunction with FIG. 2E. As shown, the flattened ovoid-shaped input control device 208F includes an additional contact surface 218. The additional contact surface 218 may be substantially planar, or flat, curved, arcuate, or include a number of undulating surfaces and/or other features. Other features may include orientation marks, indentations, raised portions, location features, combinations thereof, and the like. In some embodiments, the additional contact surface 218 may be used to provide input to the computer system 112 that is different from the input provided via the contact surface 212.

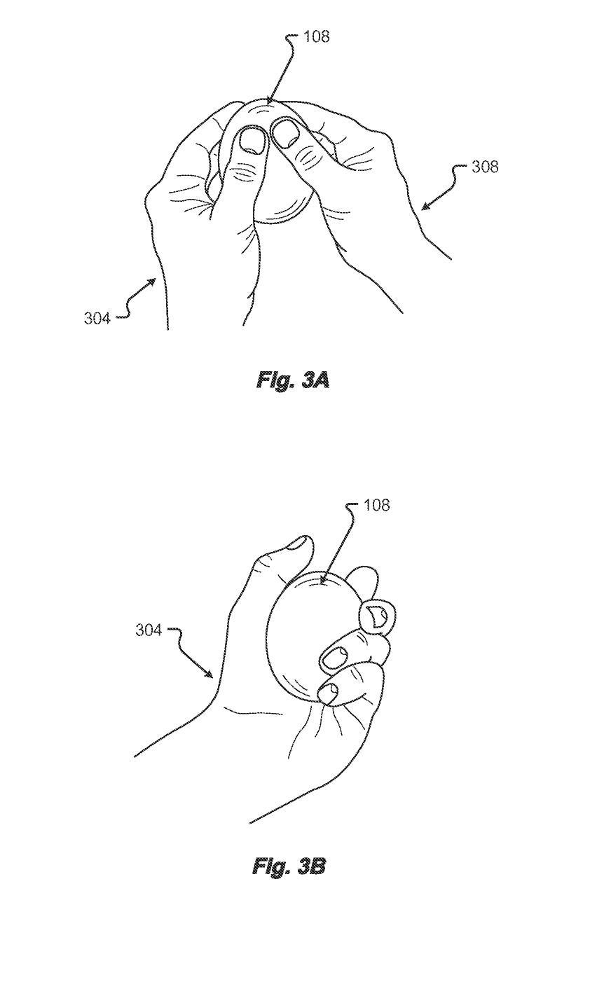

FIGS. 3A and 3B show various handheld operational states of the input control device 108. Specifically, FIG. 3A shows a two-handed operating state where a user is able to provide input to the device using both hands (e.g., via a first hand 304 and a second hand 308). FIG. 3B shows a single-handed operating state of the input control device 108 where a user is able to provide input to the device using a single, or first hand 304. Although depicted as being operated by one or more hands of a user, it is an aspect of the present disclosure that at least one extremity, body part, entity, contact tool, stylus, pen, etc., and/or combinations thereof may be used to operate the input control device 108.

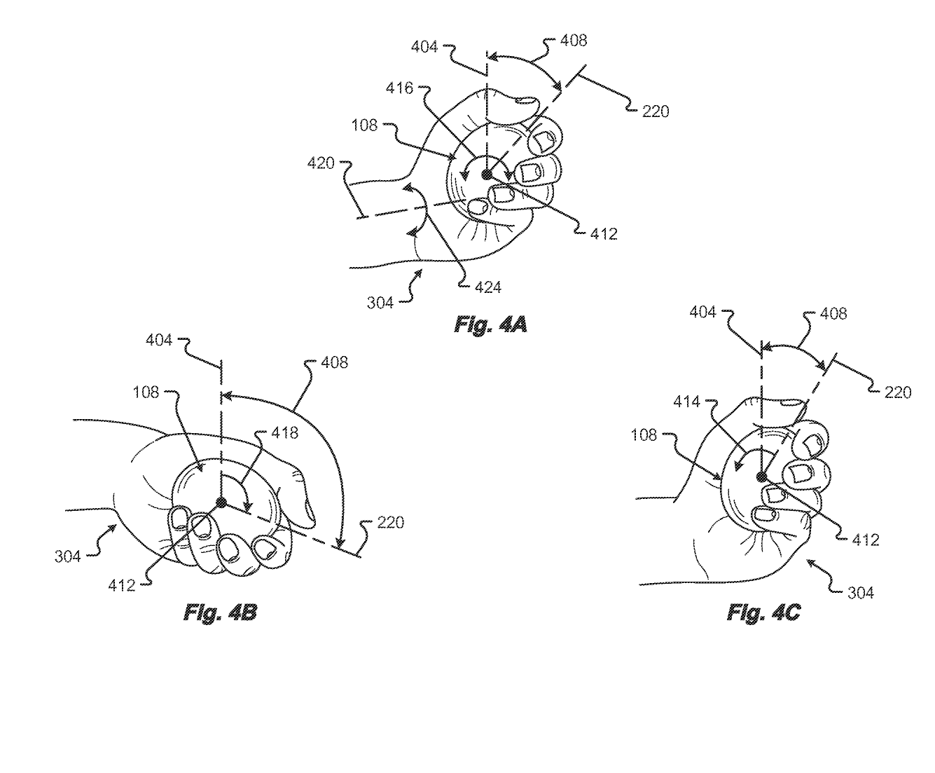

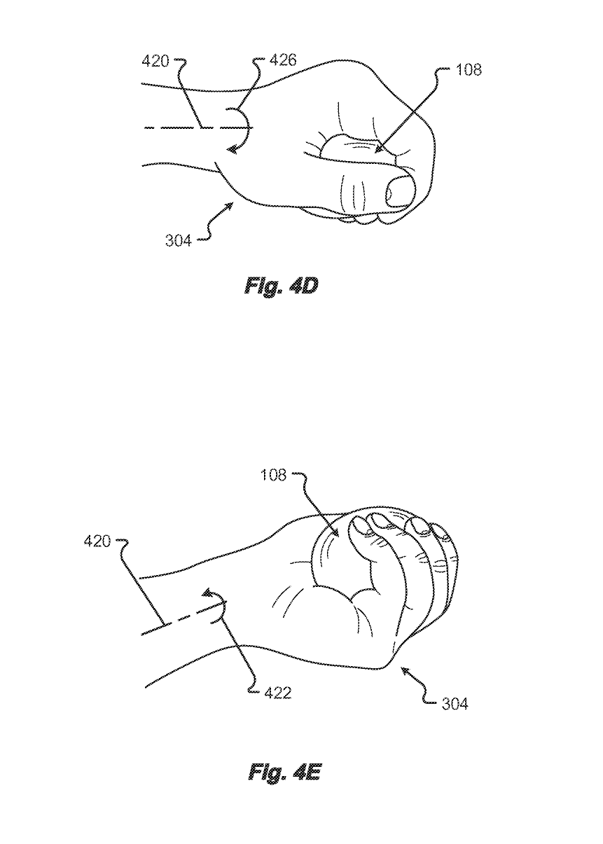

FIGS. 4A-E show various control orientations of the input control device 108 in accordance with embodiments of the present disclosure. While a limited number of orientations are shown in FIGS. 4A-E, it should be appreciated that any number of control orientations can exist depending on the specific orientation detected via the one or more orientation sensors 128 of the input control device 108. Additionally or alternatively, control instructions provided in response to receiving input from a control orientation may depend on an intensity of the orientation made (e.g., orienting the device 108 quickly or slowly), the number of orientations made, a sequence of orientations made, a continuity of orientation changes, etc., and/or combinations thereof.

In determining an orientation of the device 108, the orientation sensors 128 may refer to a pseudo-constant reference point 404 (e.g., the gravity vector, etc.) and a movement of the device 108 relative to the reference point 404. For instance, orientation may be measured using positional data of an axis 220 of the device 108 relative to the reference point 404. This positional data can include an angle, or measurement, between the axis 220 and the reference point 404, rotation in multiple directions 416 about a first axis 412 (shown extending into the page), rotation in multiple directions 424 about a second axis 420, accelerations and/or decelerations associated therewith, combinations thereof, and the like. The first axis 412 may be used to determine a “pitch” of the input control device 108. The second axis 420 may correspond to an axis running along a wrist and/or arm. In some embodiments, the second axis 420 may be used to determine a “roll” of the input control device 108. Although not shown, the “yaw” of the input control device 108 may be determined by a rotation or movement of the device 108 about the reference point 404 or the device axis 220.

FIG. 4A shows a diagram showing a first control orientation of the input control device 108 in accordance with embodiments of the present disclosure. The first control orientation may correspond to a default, or baseline, operational orientation. In some embodiments, the first control orientation may be configured to provide no active control instructions. As can be appreciated, a user may return to the first control orientation between providing input and control instructions to a computer system 112. This first control orientation may correspond to a “home” orientation position of the device 108.

FIG. 4B shows a diagram showing a second control orientation of the input control device 108 in accordance with embodiments of the present disclosure. As shown, the second control orientation shows a translation and/or rotation of the device 108 in a clockwise direction 418 about the first axis 412. This control orientation may be referred to as pitching the device 108 forward, or in a forward direction. By way of example, the second control orientation may be used to provide a navigational output in a specific direction (e.g., a vertical direction, up or down, etc.) of a rendered display or other output provided by one or more components of the computer system 112.

FIG. 4C shows a diagram showing a third control orientation of the input control device 108 in accordance with embodiments of the present disclosure. As shown, the third control orientation shows a translation and/or rotation of the device 108 in a counterclockwise direction 414 about the first axis 412. This control orientation may be referred to as pitching the device 108 backward, or in a backward direction. By way of example, the third control orientation may be used to provide a navigational output in a specific direction (e.g., a vertical direction, up or down, etc.) of a rendered display or other output provided by one or more components of the computer system 112. This specific direction may be opposite to the direction described in conjunction with FIG. 4B.

FIG. 4D shows a diagram showing a fourth control orientation of the input control device 108 in accordance with embodiments of the present disclosure. As shown, the fourth control orientation shows a translation and/or rotation of the device 108 in a clockwise direction 426 about the second axis 420. This control orientation may be referred to as rolling the device 108 right. By way of example, the fourth control orientation may be used to provide a navigational output in a specific direction (e.g., a horizontal direction, left or right, etc.) of a rendered display or other output provided by one or more components of the computer system 112.

FIG. 4E shows a diagram showing a fifth control orientation of the input control device 108 in accordance with embodiments of the present disclosure. As shown, the fifth control orientation shows a translation and/or rotation of the device 108 in a counterclockwise direction 422 about the second axis 420. This control orientation may be referred to as rolling the device 108 left. By way of example, the fifth control orientation may be used to provide a navigational output in a specific direction (e.g., a horizontal direction, left or right, etc.) of a rendered display or other output provided by one or more components of the computer system 112. This specific direction may be opposite to the direction described in conjunction with FIG. 4D

The control orientations described herein may be used in combination to provide combined navigational outputs. For instance, combining the second control orientation with the fourth control orientation may provide a diagonal navigational input of a rendered display or other output provided by one or more components of the computer system 112. Other control orientations and degrees of orientation may be used to provide different combined navigational output.

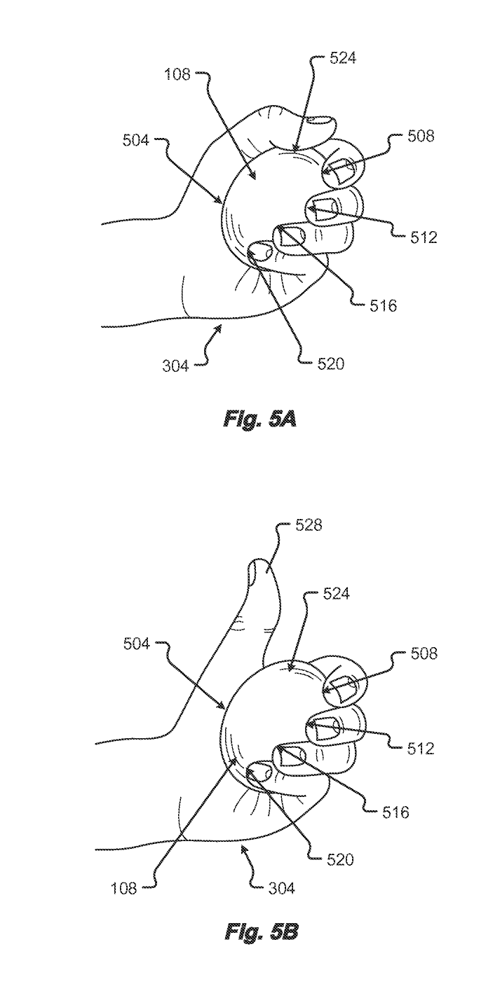

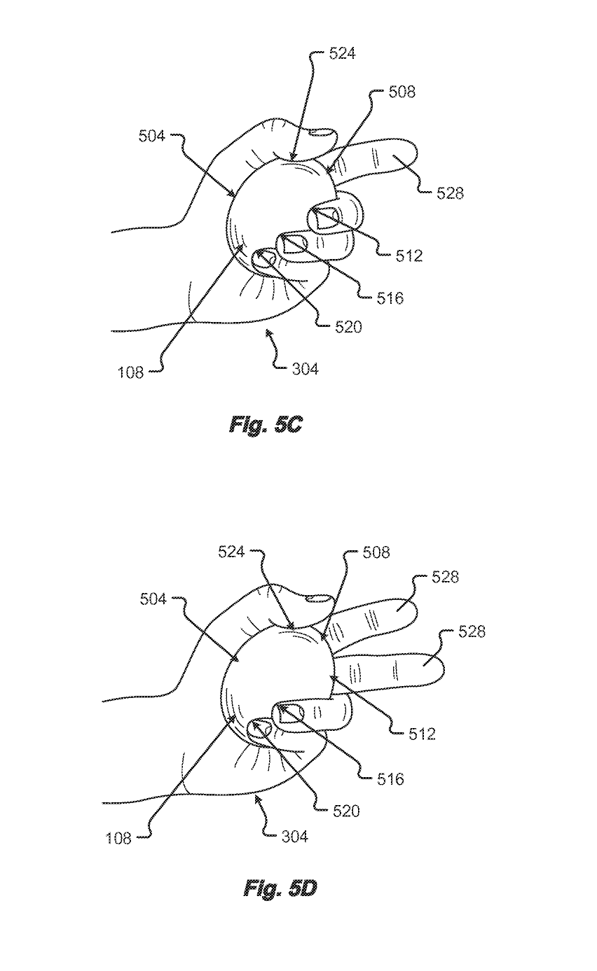

FIGS. 5A-D show various control contact patterns on the input control device 108 in accordance with embodiments of the present disclosure. While a limited number of control contact patterns are shown in FIGS. 5A-D, it should be appreciated that any number of control contact patterns can exist depending on the specific combination of digits detected via the input sensors 124 of the input control device 108. Additionally or alternatively, control instructions provided in response to receiving input from a control contact pattern on the device 108 may depend on a pressure of the contact made, an intensity of the contact made (e.g., contacting the device 108 quickly or slowly), the number of contacts made, a sequence of contacts made, a continuity of contact pattern changes, etc., and/or combinations thereof.

In some embodiments, the input control device 108 can be activated or initiated by grasping or holding the input control device 108 as shown in FIG. 5A. Activation may be equivalent to turning the device on or waking the device from a low-power state. In one embodiment, the activation or initiation of the device 108, to provide control instructions to a computer system 112, may be made in response to detecting the palm area 504 of a user contacting the input control device 108. In some cases, this detection may be based on receiving a specific pressure applied by the palm area 504 of a user and/or one or more digits of the user in a number of contact areas 508, 512, 516, 520, 524.

It is an aspect of the present disclosure that the input control device 108 configures itself to receive input from a user based on how the device 108 is positioned in the hand of a user. In one embodiment, the input control device may continually and dynamically reconfigure itself based on the position in a user's hand. In any event, the input control device 108 may include a number of input sensors 124 arranged about the periphery of the device 108 and configured to detect input applied from any contact area 240. When a user grasps the device 108, the controller 132 receives information from the input sensors 124 corresponding to the locational arrangement of one or more of the user's palm area 504, digits, and other features. Because this locational arrangement of features is substantially constant for a particular user, the device 108 can determine the where the user's digits and/or palm area 504 are on the device at any point in time. The device 108 can map, or remap, input sensors 124 to match a locational arrangement of features in an ad hoc manner when the device is grasped. In one embodiment, the device 108 may dynamically assign input sensors 124 that are adjacent to the user's features (e.g., digits, palm, etc.) in the locational arrangement to interpret input received according to the which one or more of the user's features provides an input based on the locational arrangement. This input may be interpreted by the controller 132 based at least partially on at least one of the particular feature providing the input, the condition of the input (e.g., pressure, size, etc.), and the like.

FIG. 5B is a diagram showing a second control contact pattern on an input control device 108 in accordance with embodiments of the present disclosure. As shown, a user has lifted a digit from a contact area 524 of the device 108. In this example, the user maintains contact with the device 108 at multiple digit contact areas 508, 512, 516, 520 and at least one palm contact area 504. The input sensors 124 of the input control device 108 may detect that the lifted digit 528 has been removed from a particular contact area 524 of the device 108. In response, the controller 132 may provide a control instruction to a computer system 112 based on interpreting the second control contact pattern. The control instruction may be associated with a prompt, or other output, from the computer system 112. For instance, the computer system 112 may associate particular control contact patterns with one or more instructions, controls, and/or options available to a user. In some embodiments, these particular control contact patterns may be provided to a user via a rendered image on a display of the computer system 112 (e.g., where a particular control contact pattern is rendered adjacent to a selection or navigation output, etc.).

FIGS. 5C-D are diagrams showing third and fourth control contact patterns on an input control device 108 in accordance with embodiments of the present disclosure. As shown, each control contact pattern may include various combinations of lifted digits 528 and contact areas 504, 508, 512, 516, 520, 524. The input sensors 124 of the input control device 108 can detect any combination of digits that are in contact with, or that have been removed from, the input control device. In any event, the controller 132 can provide a control instruction to a computer system 112 based on interpreting the control contact pattern. The control instruction may be associated with a prompt, or other output, from the computer system 112. For instance, the computer system 112 may associate particular control contact patterns with one or more instructions, controls, and/or options available to a user. In some embodiments, these particular control contact patterns may be provided to a user via a rendered image on a display of the computer system 112 (e.g., where a particular control contact pattern is rendered adjacent to a selection or navigation output, etc.).

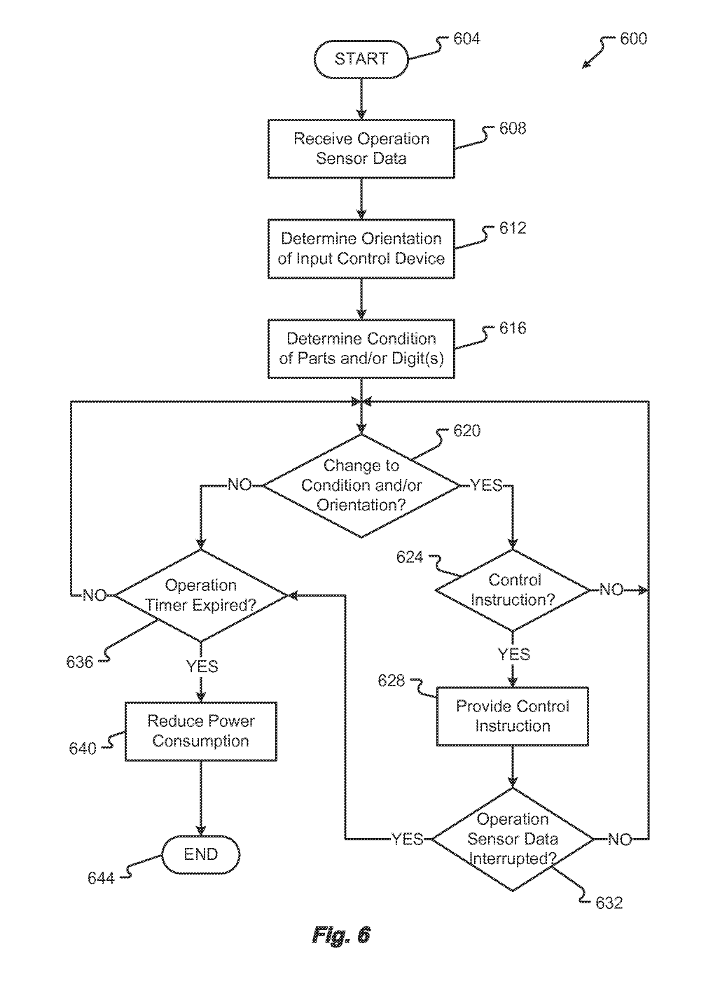

FIG. 6 is a flow or process diagram depicting a method 600 for controlling an input control device 108 in accordance with embodiments of the present disclosure. While a general order for the steps of the method 600 is shown in FIG. 6, the method 600 can include more or fewer steps or can arrange the order of the steps differently than those shown in FIG. 6. Generally, the method 600 starts with a start operation 604 and ends with an end operation 644. The method 600 can be executed as a set of computer-executable instructions executed by a processor and/or controller 132 and encoded or stored on a computer readable medium. Hereinafter, the method 600 shall be explained with reference to the systems, components, modules, mechanisms, software, data structures, etc., described in conjunction with FIGS. 1-5.

The method 600 begins at step 604 and proceeds when operational sensor data is received by the device 108 (step 608). Operational sensor data may correspond to any information that indicates the input control device 108 is in an operational state. One example of operational sensor data may include an activation, or initialization, instruction. For instance, a user may provide a particular contact pattern, orientation, and/or pressure to activate the input control device 108 (e.g., via squeezing the input control device 108, applying pressure to a particular region or regions of the device 108, contacting the device 108 at one or more points, etc.). In some embodiments, the operational sensor data may be used by the input control device 108 in determining whether the device 108 should remain in an active state. In one embodiment, an active state may correspond to a full power state of the device. The active state of the device 108, in any embodiment, may correspond to a state in which the device 108 is ready to receive control input provided by a user.

The controller 132 of the input control device 108 may determine to change the operational state of the device based on one or more of a type of operational sensor data received, a lack of operational sensor data received, timer values, rules, and the like. A type of operational sensor data may correspond to a measurement associated with a provided contact pattern, orientation, and/or pressure applied to the device 108. For instance, a user may apply a first pressure, P1, to the device 108 to activate the device 108 and a second pressure, P2, to maintain the device in an operational state. In one embodiment, the first pressure may be greater than the second pressure, P1>P2. As another example, a user may remove, or reduce, the pressure applied to the device 108. Removing, or reducing, the pressure applied to the device 108 may correspond to a deactivation instruction. In some embodiments, when a value of the pressure applied to the device 108 meets a particular threshold value, the controller 132 may change the operation and/or state of the device 108. pressures may be adjusted applied may need

The method 600 continues by determining an orientation of the input control device 108 (step 612). The orientation of the device 108 may correspond to a position of the device relative to a reference point. Additionally or alternatively, the orientation of the device 108 may correspond to a position of the device 108 in three-dimensional space. In some embodiments, the reference point may be a constant or relative value. For example, the reference point may correspond to the gravity vector, geomagnetic reference, combinations thereof, and the like. Additional examples of device 108 orientations are described in conjunction with FIGS. 4A-E. As disclosed herein, the device 108 may include at least one device reference, such as a central axis 212, a position of an orientation sensor inside the device 108, a top or bottom of the device 108, a coordinate system origin, etc. In any event, an orientation of the device 108 may be determined based on a comparison, or other quantifiable relationship, between the reference point and the device reference. The orientation of the input control device 108 may correspond to an initial, or baseline, orientation.

By way of example, a user may determine to activate the input control device 108 while the device 108 is concealed in a pocket, under a table, or otherwise hidden from view. In this example, the user may provide an initialization input and set the baseline orientation upon which all orientation input controls may be based. In some embodiments, the initialization input may automatically set the baseline orientation as the orientation and/or position of the device 108 is in when the input is received. When a user manipulates the device 108, this default orientation may serve as a “home” orientation position of the device 108. Among other things, setting the baseline orientation of the device 108 allows a user to comfortably position the device 108 for ergonomic control (e.g., by providing a reorientation or repositioning of the device, etc.) whether the device 108 is concealed or conspicuous.

Next, the method 600 proceeds by determining a contact condition of one or more features (e.g., digits, body parts, or control entities, etc.) positioned about the device 108 (step 616). In some embodiments, one or more of digits of a user's hand may be in contact with at least one contact surface 212, 218 of the input control device 108. Additionally or alternatively, parts of a user's hand (e.g., the palm, knuckles, joints, etc.) may be in contact with, or adjacent to, the at least one contact surface 212, 218 of the input control device 108. The relative position of these digits and/or parts to one another may correspond to a contact control condition that can be measured via one or more of the input sensors 124 of the device 108. Additionally or alternatively, the location of the digits and/or parts on or about particular points on the device 108 may correspond to a contact control condition.

In some embodiments, the user may set the baseline contact control condition upon which all digit-based input controls are based. In some embodiments, the first-determined (e.g., initialization) contact control condition may serve as the baseline contact control condition. This first-determined contact control condition may be set automatically as the position of the features of a user's hand on or about the device 108 are in when the initialization input is received. When a user manipulates the device 108, this default contact control condition may serve as a “home” contact control condition of the device 108. Among other things, setting the baseline contact control condition of the device 108 allows a user to configure which features of a user's hand may be used to provide input to the device 108. Additionally or alternatively, setting the baseline contact control condition may include configuring the device 108 to receive input from a user having one or more hand conditions (e.g., missing digits, extra digits, increased or decreased size of individual digits, deformities and/or particular contacting patterns, a particular size of a user's hands, etc.). This configuration allows the device 108 to be used by a user having any combination of detectable input features (e.g., fingers, toes, palms, body parts, etc.) with any number of conditions. In some embodiments, the input control device 108 may be reconfigured to another user having a different combination of detectable input features and/or conditions associated therewith. In one embodiment, various input sensors 124 (e.g., the input sensors 124 adjacent to one or more input entities of a user, etc.) of the input control device 108 may be dynamically assigned to receive, and/or interpret input received, from one or more input entities based on the baseline locational arrangement determined. By way of example, although a device 108 may move within the hand of a user the input provided by the user can always be provided by the same digits of the hand. In this example, because the baseline locational arrangement may associate particular digits with a particular location in the locational arrangement, as a user applies contact to the device 108, the baseline locational arrangement may be detected and input can be provided based on this arrangement.

The location and/or relative position of digits and/or parts to one another may be determined using one or more input sensors 124. When a user grasps the input control device 108, the user may provide a contact area for each hand feature that contacting the device 108. These contact areas may be associated with a particular contact area size. In some cases, the size and/or contact pattern of each contact area may serve to indicate that a particular hand is contacting the device 108. Whether a particular hand is contacting the device can be determined via the controller 132 interpreting the contact data (e.g., the contact pattern and/or size of each contact area, etc.) and comparing the contact data to stored contact data. When the contact data matches stored contact data, the controller 132 may associate the user's contact with a particular type of contact (e.g., single-handed contact, left-handed contact, right-handed contact, multiple-handed contact, etc.).

In one embodiment, the input sensors 124 may be used to determine a locational arrangement of features associated with a user's operating hand or hands. The image sensors may determine a series of contacted areas of the device. In the series of contacted areas, a substantially continuous region of contact areas may be associated with a user's palm and/or digit location. The existence, or lack of existence, of a substantially continuous contact region may indicate whether the device is being held in a user's left hand or right hand (e.g., where an open contact region exists opposite a substantially continuous contact region and/or digit pattern, etc.), or by both hands (e.g., where a substantially continuous contact region does not exist, etc.). In some embodiments, the input sensors 124 may utilize image sensors and/or temperature sensors to determine contact areas and/or regions. In one embodiment, an image sensor may be used to detect at least one print associated with a user's contacting hand (e.g., fingerprint, palm print, etc.).

The method 600 continues by determining whether there is any change to the input conditions, that is, the contact control condition and/or orientation of the device 108 (step 620). For instance, control instructions may be provided based on one or more of the contact control condition detected and an orientation of the device 108. A change to the input conditions may correspond to a change to the baseline contact control condition or some other contact control condition detected subsequent to initialization of the input control device 108. A change to the orientation of the device 108 may correspond to a change to the baseline orientation or some other orientation detected subsequent to initialization of the input control device 108. In some embodiments, determining a input conditions change may include determining that a plurality of changes to the input conditions matches a particular sequence, arrangement, or series. The particular sequence, arrangement, or series may be stored in memory 120. In one embodiment, the controller 132 may interpret one or more signals from the input sensors 124 and or orientation sensors 128 and compare the interpreted signals to data stored in the memory 120 representing the particular sequence, arrangement, or series. Additionally or alternatively, the plurality of changes may correspond to at least one of a sequence of movements, control inputs, and the like having an order and/or timing associated therewith.

In the event that a change is detected in step 620, the method 600 may continue by determining whether the change corresponds to a control instruction (step 624). In some embodiments, the controller 132 may determine whether the detected change meets one or more rules for providing a control instruction. This determination may include referring to memory having one or more stored control instruction conditions. A stored instruction condition may be associated with a measurable value (e.g., pressure, temperature, image, etc.), a contact pattern (e.g., a pattern or number of digits contacting one or more contact areas of the device, a region of contact areas detected, etc.), threshold values, program prompts (e.g., receiving a change in response to a program prompt provided by an application running on the computer system 112, etc.). It is an aspect of the present disclosure that the change may be required to overcome minor movement, orientation, and/or contact control condition deviations. For example, as a user is manipulating the device, the user may impart small movements or slightly change contact control conditions from one or more contacting digits that are not intended to qualify as control instructions. If the movements and/or contact control conditions do not meet a minimum threshold value, the movements and/or contact control conditions will not be considered as an input necessary to provide a control instruction and the method 600 may return to step 620. It should be appreciated that the minimum threshold value may be set, reset, and/or configured for specific control instructions. In one example, a precision movement instruction may have a minimum threshold value that is set lower than a general navigation instruction. The minimum threshold value for providing a control instruction may be application specific. In some cases, the minimum threshold value may be configured for a particular application.

When a control instruction is determined from the input provided by the user via the various sensors 124, 128 of the device 108, the method 600 continues by providing the control instruction (step 628). In some embodiments, the control instruction may be provided to a computer system 112 via one or more communication paths. Additionally or alternatively, receipt of the instruction may be provided to the user via one or more of the feedback mechanisms 136 associated with the device 108, a haptic feedback device 152 associated with the computer system 112, an audio I/O device 160, a video I/O device 164, or other component associated with the computer system 112.

In some embodiments, the method 600 may proceed by determining whether operational sensor data has been interrupted (step 632). By way of example, a user may release the device 108 from being held or contacted because the user may not wish to use the device 108 any longer. As another example, a user may wish to continue to hold the device 108 but may wish to turn it off or place the device in a low-power state. In yet another example, a user may simply wish to turn off the device by providing a deactivation input. In this example, a user may provide a specific combination of inputs or contact control conditions to the device to deactivate it. For instance, a user may actuate a switch, provide a particular contact pattern, provide a particular orientation of the device 108, apply a particular pressure via one or more contact areas, etc., or combinations thereof. If the operational sensor data is not interrupted, the method 600 may return to step 620.

In the event that the operational sensor data is interrupted, the method 600 may continue by determining whether an operational timer has expired (step 636). In one example, the operational timer may be configured to minimize false deactivation signals where the device 108 has slipped from the grasp of a user accidentally. In another example, the operational timer may be used to prevent deactivation when a control instruction input may require temporarily releasing the device 108 from a user's grasp. If the operational timer has not expired before receiving another input from the user, the method 600 may return to step 620.

The method 600 may continue by reducing the power consumption of the device when the operational timer has expired (step 636). Reducing the power consumption of the device may include, but is not limited to, turning the device off, placing the device in a “standby” power saving mode, placing the device in a “hibernate” mode, and/or combinations thereof. In any event, reducing the power consumption may correspond to providing power to less than all of the components of the device 108. In some embodiments, the device 108 may configured to turn on or come out of reduced power consumption mode based on an input provided by the user. For example, the user may shake the device to wake it from the “standby” or “hibernate” modes. Shaking may provide a particular combination of inputs that is configured to repower the device 108. The method 600 ends at step 644.

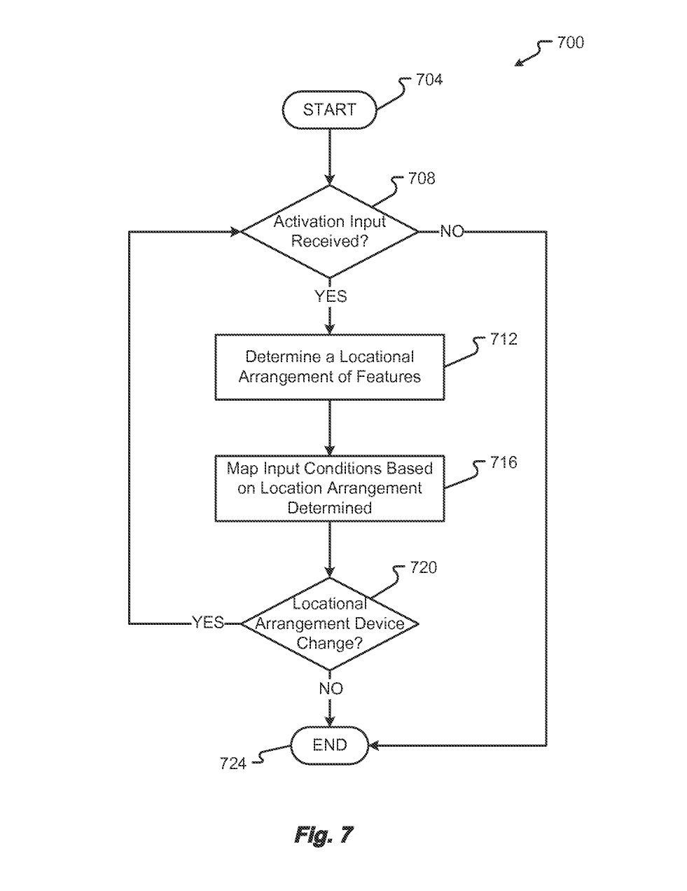

FIG. 7 is a flow or process diagram depicting a method 700 of dynamically configuring input conditions for an input control device 108 in accordance with embodiments of the present disclosure. While a general order for the steps of the method 700 is shown in FIG. 7, the method 700 can include more or fewer steps or can arrange the order of the steps differently than those shown in FIG. 7. Generally, the method 700 starts with a start operation 704 and ends with an end operation 724. The method 700 can be executed as a set of computer-executable instructions executed by a processor and/or controller 132 and encoded or stored on a computer readable medium. Hereinafter, the method 700 shall be explained with reference to the systems, components, modules, mechanisms, software, data structures, etc., described in conjunction with FIGS. 1-6.

The method 700 begins at step 704 and proceeds when activation, or operational, input is received and/or detected (step 708). This input may correspond to the operational sensor data received by the device 108 as described in conjunction with FIG. 6. In some embodiments, the activation input may correspond to any input that is provided indicating that the device 108 is in an initial or continuing state of operational use. For instance a device 108 that is not being held, or has not been held in some time, may not receive activation input. In some embodiments, the act of holding the device 108 may be sufficient to provide activation input to the device 108. If no activation input is received the method 700 ends at step 724.

In the event that activation input is received, the method 700 may continue by determining a locational arrangement of features on or about the device 108 (step 712). This locational arrangement of features may correspond to locational information of contacting and/or non-contacting entities. For example, the digits of a user's hand may be in contact with one or more specific contact areas of the device 108, while other parts of the user's hand may not be directly contacting the device 108. Continuing this example, one or more input sensors 124 may be configured to determine contacting entities (e.g., pressure sensor, piezoelectric sensor or transducer, capacitive sensor, potentiometric transducer, inductive pressure transducer, strain gauge, displacement transducer, resistive touch surface, capacitive touch surface, image sensors, cameras, temperature sensors, IR sensors, etc.), while other input sensors 124 (e.g., image sensors, cameras, temperature sensors, IR sensors, etc.) may be configured to determine non-contacting entities. In some embodiments, a range or distance to non-contacting entities may be determined via the signals provided by the input sensors 124.

The locational arrangement of features may be generally or uniquely associated with a user's operating hand or hands. As can be appreciated, each user may have common, or standard, relational data between various features of the hand. For instance, a user having a thumb and four fingers typically has a palm connecting the thumb and four fingers. Once the palm and a plurality of digits belonging to the user are identified in contact with the device 108 a particular hand may be determined to be operating the device. For example, the input sensors may determine a series of contacted areas of the device. In the series of contacted areas, a substantially continuous region of contact areas may be associated with a user's palm and/or digit location. The existence, or lack of existence, of a substantially continuous contact region may indicate whether the device is being held in a user's left hand or right hand (e.g., where an open contact region exists opposite a substantially continuous contact region and/or digit pattern, etc.), or by both hands (e.g., where a substantially continuous contact region does not exist, etc.). When a user has non-standard features, such as, more or fewer digits than common, varying degrees of hand injuries, or any deformities to the hand, a locational arrangement of features may be uniquely associated with that user.

Whether generally or uniquely associated with a user, the locational arrangement of features may be determined by one or more hand feature contact pattern, pressure, location, number, measurement, and/or relationship. For instance, the number and distances between points or features of a user's thumb, fingers, palm, etc., and/or combinations thereof may be used to determine the locational arrangement. As these numbers and distances typically remain constant for a particular user, the locational arrangement can be used by the device 108 in determining a map of the user's digits in relation to at least one contact surface 212, 218 regardless of the orientation of the device in the user's hand. In other words, the device 108 can receive input from any input sensor 124 of the device that is based on the user's locational arrangement of features on or about the device. In contrast, conventional input devices require input from a specific input key, sensor, or switch, and do not take into account the features of the user. As such, input provided to a conventional input device requires a user knowing where each input key, sensor, or switch is before input can be entered. The present disclosure offers the benefit of allowing the input control device 108 to map input sensors 124 to correspond to the locational arrangement of features of a user and receive input based on that arrangement.

For example, during an initialization of the device 108, a user may be instructed to hold the device in a neutral position grasping the device with all digits while applying a pressure to the device 108. The device 108 may automatically determine conditions associated with each contact area including, but not limited to, the location, pressure, and/or number of contact areas, etc. The user may be further prompted to move particular digits and/or apply various levels of pressure during the initialization. This information may be used to register the capabilities of a user interfacing with the device 108. The capabilities may be stored in the memory 120 of the device 108 and/or the memory 136 of the computer system 112. In some embodiments, an image sensor may be used to detect and register at least one print associated with a user's contacting hand (e.g., fingerprint, palm print, etc.).

Next, the method 700 continues by mapping the input conditions based on the determined locational arrangement of features (step 716). As described above, the input control device 108 can map various input sensors 124 to correspond to the locational arrangement of features of a user and then receive input based on the locational arrangement and map. Mapping input conditions may include determining a contact control condition of a user's hand and an orientation of the device 108. In some embodiments, the determined contact control condition and orientation may correspond to a baseline, or default, contact control condition and orientation of the device 108, or a default map. In one embodiment, the default map may remain in effect, until a relationship between the locational arrangement and a reference position of the device 108 changes (e.g., if the device 108 is moved inside the hand while the hand remains unmoved).

The method 700 may proceed by determining whether a relationship between the locational arrangement of features of a user's hand and a reference position of the device 108 has changed (step 720). Once a locational arrangement of features is determined or mapped based on a position of the device 108 in the user's hand the input control device 108 is configured to receive input based on that arrangement or map. In some cases, a user may reorient a device 108 inside the user's hand, whether intentionally or accidentally, and the relationship between the locational arrangement and the reference position may change. For example, a user may drop the input control device 108 and pick the device 108 back up. As another example, a user may spin or rotate the device 108 in the hand. In yet another example, a user may substantially reorient the device 108 within the hand (e.g., while the user's hand remains in a substantially constant position) to achieve a comfortable grasp of the device 108. In any event, the method 700 may return to step 708 and remap the various input sensors 124 of the device 108 to accommodate the new relationship of the locational arrangement to the reference position of the device. It is an aspect of the present disclosure that this remapping (i.e., reconfiguring the relationship/input conditions map) may be performed dynamically and continuously or whenever a change is detected at step 720. If no change is determined, the method 700 ends at step 724.

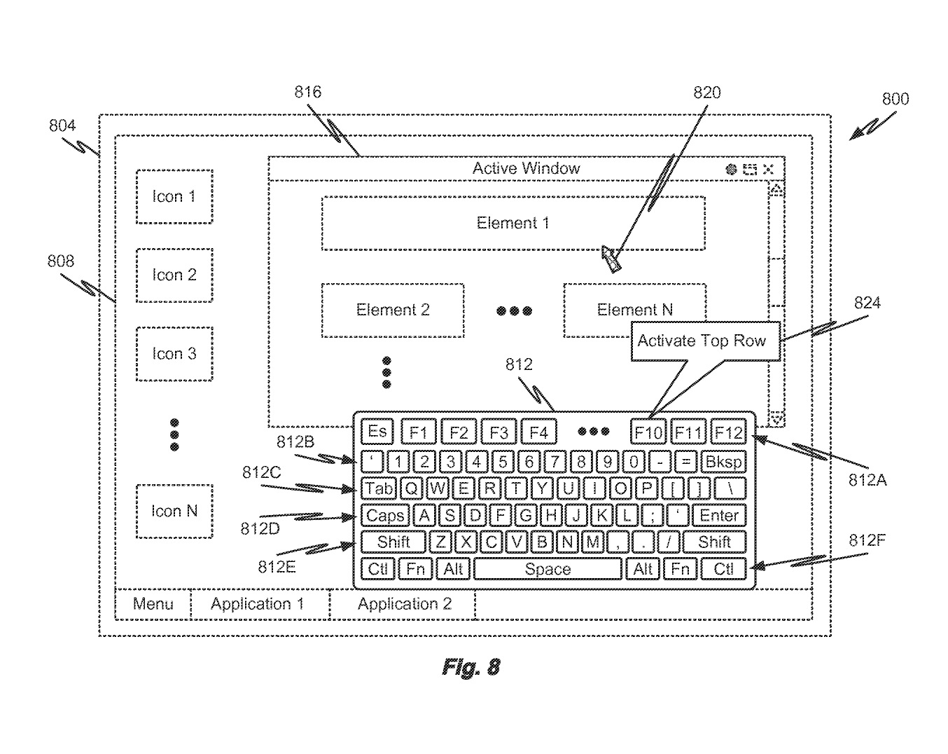

Referring now to FIG. 8, a diagram of a user interface control environment 800 is shown in accordance with embodiments of the present disclosure. The user interface control environment 800 may include a display device 804 that is configured to render at least one graphical user interface 808. In some embodiments, the display device 804 may be the video I/O device 164 of the computer system 112. By way of example, the display device 804 may correspond to a display associated with a wearable computer (e.g., the Prism or visual overlay of Google Glass, heads up display, transparent or semi-transparent display, etc.). In any event, the display device 804 may be configured to present one or more images associated with the computer system 112 and provide visual feedback to a user who is controlling aspects of the computer system 112 and/or one or more elements of the graphical user interface 808. As can be appreciated, these aspects and/or elements may be controlled via the input control device 108 as provided in this disclosure. One example of a graphical user interface 808 may include at least one rendered image associated with an operating system of a computer and/or application running on the computer.

In some embodiments, the graphical user interface 808 may be configured to render a virtual input interface 812. Although shown as a virtual keyboard in a typical physical keyboard layout, the virtual input interface 812 can include any number of interface and/or control elements in any number of arrangements, having static and/or dynamic portions. Examples of these interface and/or control elements can include, but are in no way limited to, one or more input keys, text input options, directional arrows, navigation elements, switches, toggles, selectable elements, context-sensitive input areas, etc., and/or combinations thereof. Additionally or alternatively, the virtual input interface 812 may be arranged as one or more keys, sections, areas, regions, key clusters, and/or combinations thereof. For example, the virtual input interface 812 is shown having a first row 812A, a second row 812B, a third row 812C, a fourth row 812D, and a fifth row 812E. The first row 812A may correspond to certain function keys of a keyboard (e.g., Escape, F1, F2, . . . , F12, and the like). In some embodiments, the second row 812B may correspond to the number row of a keyboard, the third row 812C may correspond to a specific letter row, and so on.

It is an aspect of the present disclosure that the virtual input interface 812 may provide visual feedback corresponding to input detected at the input control device 108. This visual feedback may include changing an appearance associated with particular keys, areas, and/or other portions of the interface 812. One example of changing the interface may include changing a color, or highlight, of a key in the virtual input interface 812 depending on an input location and/or input pressure detected via the input control device 108. Another example of changing the interface may include dynamically changing a layout or assignment of one or more keys in the virtual input interface 812. Continuing this example, a user may provide a shift input at the input control device 108 and in response the appearance of the keys of the virtual keyboard may be changed from a first state showing a first selectable input to a second state showing a different second selectable input (e.g., the number 3 key, when shifted may display the pound “#” symbol, etc.).

The graphical user interface 808 may include a number of interface areas, such as, application icons, operating system windows, and/or other rendered elements. The input control device 108 may be configured to provide input at one or more of these interface areas. In one embodiment, input received at the input control device 108 may be configured to control input at an active window 816 of an application that is rendered to the graphical user interface 808.

In some embodiments, a navigational indicator 820 may be rendered by the display device 804. The navigational indicator 820 may correspond to a cursor or a mouse pointer. This navigational indicator 820 may move about the graphical user interface 808 as a user provides navigational input via the input control device 108. Additionally or alternatively, the navigational indicator 820 may provide a user with visual feedback corresponding to a location of the graphical user interface 808. This visual feedback may include providing tooltips, selecting elements, interacting with interface areas, highlighting areas, etc., and/or combinations thereof.

The virtual input interface may be associated with at least one control identifier 824. The control identifier 824 may include information to a user that is associated with providing control via the input control device 108. For example, the control identifier 824 may include control instructions, tooltips, functional descriptions, and/or the like. The control identifier 824 may be associated with one or more areas of the virtual input interface 812. In some embodiments, the control identifier 824 may be represented as an image, text, character, and/or combinations thereof. For example, the control identifier 824 may be rendered as a hand image that is associated with a particular area (e.g., a key, row of keys, cluster of keys, etc.). Continuing this example, the hand image may show a configuration of digits to activate and/or select a particular key, enable a particular function, and/or otherwise provide input. As can be appreciated, different hand images showing different digit combinations may be rendered to the graphical user interface 808. In one embodiments, these control identifiers 824 may serve as shortcuts and/or reminders of control functionality associated with the input control device 108.

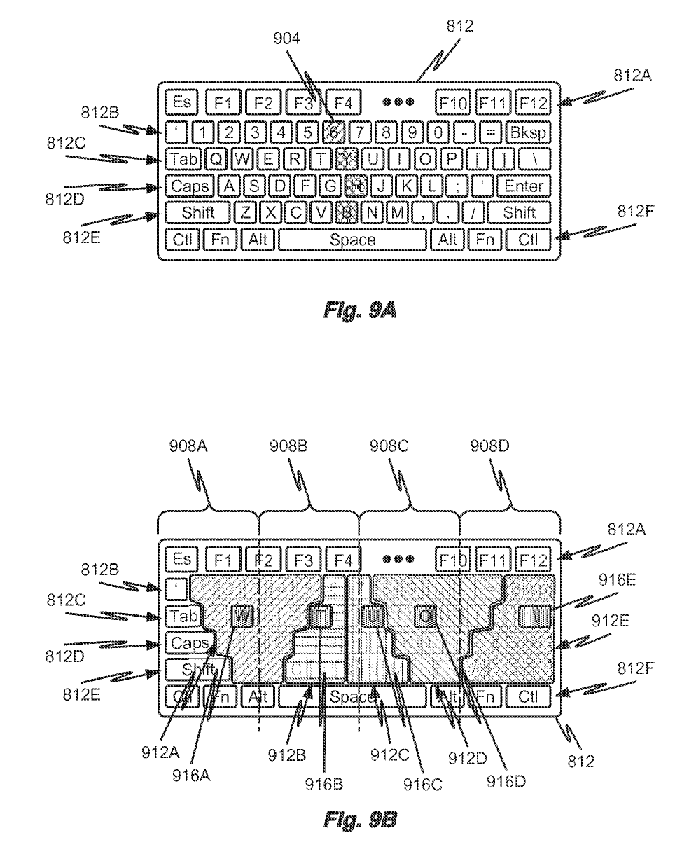

FIGS. 9A and 9B show diagrams of a virtual input interface 812 having various input arrangement embodiments. In one embodiment, a row of keys of the virtual input interface 812 may be associated with a particular digit of a user handling the input control device 108. In another embodiment, a cluster of keys of the virtual input interface 812 may be associated with a particular digit of the user handling the input control device 108. As provided above, the input control device 108 may determine the baseline locational arrangement of one or more digits relative to one another and dynamically assign input sensors adjacent to the one or more input entities to receive input based on the baseline locational arrangement. Even if the input control device 108 moves within the hand of the user, the device 108 may assign the input sensors that are newly adjacent to the one or more input entities to receive input based on the baseline locational arrangement. Among other things, this baseline locational arrangement and dynamic assignment of input sensors allows for configurability based on a user's available number of digits (e.g., fewer digits than normal, more digits than normal, hand and/or digit deformities, hand and/or digit strengths, hand and/or digit weaknesses, combinations thereof, and the like). In any event, input provided by a user may depend on a particular input interface arrangement of the virtual input interface. The input interface arrangement may determine how input provided by a user at the input control device 108 is interpreted by a computer system 112. This interpretation may include one or more of providing specific control functions, mapping digits to regions of the virtual input interface, providing control instructions based on digit contact, and the like. In some embodiments, the input interface arrangement may be shown, or indicated, on the virtual input interface 812.

FIG. 9A shows a diagram of a first embodiment of a virtual input interface 812 in accordance with embodiments of the present disclosure. In particular, the virtual input interface 812 shown in FIG. 9A includes an arrangement where the second row 812B may be associated with, or assigned to receive, input from a first digit of a user. In some embodiments, the other rows may be assigned to receive input from one or more other digits of the user. For instance, the third row 812C may be associated with a second digit of the user, the fourth row 812D may be associated with a third digit of the user, and the fifth row 812E may be associated with a fourth digit of the user. It is an aspect of the present disclosure that selection of a particular key of the virtual input interface 812 may be accomplished by applying a particular pressure of one of the digits of the user to the input control device 108. In one embodiment, as a user is applying pressure to the input control device 108, the device 108 may provide a tactile feedback to the user (e.g., vibration, etc.) indicating that continuing to apply the pressure will result in a selection of the key. In some cases, the tactile feedback may serve to indicate that a selection has been made by the user.

In some embodiments, the specific location of each digit of a user that is contacting the input control device 108 may be graphically represented as a specific position on the virtual input interface 812. For example, a user may be applying a baseline (or default contacting) pressure to the input control device 108. In this case, the input sensors 124 of the input control device 108 that are adjacent to the contact areas of the user's digits, may be shown as the “home” position of the user's digits on the device 108. The graphical representation may correspond to an appearance associated with one or more of the keys, areas, and/or other portions of the virtual input interface 812. Similar, if not identical, to the visual feedback disclosed above, the graphical representation of digits may be indicated by a color, shading, or highlight, of a key in the virtual input interface 812. Additionally or alternatively, the color, shading, or highlighting of a key may serve to indicate a particular input pressure detected via the input control device 108 (e.g., darker colors or shading may correspond to higher pressure, while lighter colors and/or shading may correspond to lower pressure, etc.). As shown in FIG. 9A, the user may be contacting the input control device 108 in such a manner that the specific keys are shown as being contacted (e.g., keys labeled “6,” “Y,” “H,” and “B”). This graphical representation can serve as a reference from which a user may make selections and/or navigate to other keys/input areas of the virtual input interface 812.

For example, a user may roll the hand that is holding the device 108 (e.g., as shown in FIGS. 4D-4E) to move horizontally along the one or more rows 812A-F. In one embodiment, this motion may move one or more of the keys relative to the contacting digits. In another embodiment, this motion may move a highlighting, or selection box, along the keys of the one or more rows 812A-F. In some embodiments, a selection may be made by imparting a specific pressure by a specific digit applied to the input control device 108 when a desired key is highlighted in the virtual input interface 812. FIG. 9A shows a selection of key “6” 904, where the key 904 has a different shading/highlight than other contacted (e.g., “Y,” “H,” and “B”) and/or non-contacted keys. In one embodiment, a primary key or function may be selected by a user applying a first pressure to the input control device 108. In some embodiments, a secondary key (e.g., uppercase, lowercase, etc.) or function (e.g., shift function, foreign input, etc.) may be selected by a user applying a different second pressure (e.g., a deeper increased pressure) to the input control device 108.

In some embodiments, multiple fingers and/or pressures may be used to navigate to particular regions and/or select particular keys of the virtual input interface 812. For example, a two-finger pressure may be applied to the device 108 to select the sixth row 812F and/or keys located in the sixth row 812F (e.g., “Control,” “Space,” etc.). As another example, a three-finger pressure may be applied to the device 108 to select the first row 812A and/or keys located in the first row 812A (e.g., “F4,” “F12,” “Escape,” etc.). In yet another example, a four-finger pressure may be applied to the device 108 to select specific functions and/or a combination of keys (e.g., “Control+Alt+Delete,” etc.). In any event, the number and configuration of the specific input types may be at least partially configured via at least one of user, a program, and to suit the baseline locational arrangement determined.

FIG. 9B is a diagram showing a second embodiment of a virtual input interface 812 in accordance with embodiments of the present disclosure. In some embodiments, the virtual input interface 812 may be separated into one or more clusters of keys. Each cluster of keys can be associated with a particular digit of the user. By way of example, one or more keys in a cluster of keys may be input via the particular digit. In some embodiments, the one or more keys in a cluster may be input via one or more digits of a user. In one embodiment, each cluster may include a “home” location of the digit when contacting the input control device 108. The “home” location may correspond to available input digits in a baseline locational arrangement. These available digits, when in contact with the device 108, may provide a contact input and highlight any keys of the “home” location of each digit. The highlighting may include a shading, hatching, pattern, color, and/or other appearance that is displayed by the graphical user interface 808. In some embodiments, the “home” keys may serve as a reference from which a user may make selections and/or navigate to other keys/input areas of the virtual input interface 812.

As shown in FIG. 9B, the clusters of keys of the virtual input interface 812 can include various combinations of one or more keys. In one embodiment, the clusters of keys may be arranged in zones 908A-D. For instance, first zone 908A may include any of the keys that fall within, or at least partially within, an area defined by the first zone 908A. As can be appreciated, the virtual input interface may be arranged in any number of zones. In another embodiment, the clusters of keys may be arranged in areas. For example, the first area 912A may include keys associated with numbers “1-5,” and letters “Q,” “W,” “E,” “R,” “A,” “S,” “D,” “Z,” and “X.” In the first cluster of keys 912A the key associated with the letter “W” may serve as the “home” key. It should be appreciated, that each of the areas 912A-E can include more or fewer keys than depicted in FIG. 9B. Additionally or alternatively, the virtual input interface 812 may be separated into more or fewer clusters of keys than shown.

In any event, the arrangement of the clusters of keys may be configured to suit the baseline locational arrangement of a user. For example, the input control device 108 can determine the baseline locational arrangement of a user who may only have particular number of available input digits. In this example, the virtual input interface 812 may be arranged into clusters of keys equaling the particular number of available input digits of the user. More specifically, the input control device 108 may determine that a user has six digits on a hand that is operating, or handling, the device 108. In this example, the virtual input interface 812 may be separated into six clusters of keys. In another example, the input control device 108 may determine that a user has only two digits on a hand that is operating, or handling, the device 108. In this case, the virtual input interface 812 may be separated into two clusters of keys.

The navigation and selection input described in conjunction with FIGS. 1-9A can include other navigation and selection input as disclosed in conjunction with FIG. 9B, or vice versa. For instance, input may be provided by moving digits along the contact surface 212 of the input control device 108. In some embodiments, these movements of the digits along the contact surface 212 of the device 108 may be made to highlight and/or select an adjacent key in a cluster or row of keys. In one embodiment, the device 108 may accept input via sliding a digit along the contact surface 212. Similar to determining the arrangement of the clusters of keys, the configuring types of input received from a user may depend on the baseline locational arrangement associated with the user. For instance, a user may only have two digits (e.g., a middle finger and a pointer). In this example, the virtual input interface 812 may allow for vertical selection of keys and/or navigation about the interface 812 based on a sliding motion of the finger detected at the input control device 108. Sliding the finger along the contact surface 212 of the input control device 108 can differentiate between the rows (e.g., between input at a second row 812B and a third row 812C, etc.). In some embodiments, a deeper pressure of both fingers may be applied by the user to the input control device 108 that allows the user to make a selection from, or navigate to, a particular row (e.g., the top or first row 812A, etc.). In one embodiment, a lighter pressure of both fingers may be applied by the user to the input control device 108 that allows the user to make a selection from, or navigate to, a different row (e.g., the bottom or sixth row 812A, etc.). It should be appreciated that any of the user inputs disclosed herein may be combined to perform various functions. For instance, the device 108 may be tipped, tilted, rolled, or otherwise oriented to perform a special function. Additionally or alternatively, this orientation control may be coupled with a digit contact pattern and/or pressure to provide the special function.

It should be appreciated that while embodiments of the present disclosure have been described in connection with a wearable computer system, embodiments of the present disclosure are not so limited. In particular, those skilled in the computer arts will appreciate that some or all of the concepts described herein may be utilized with a traditional computer system, an Internet-connected computer system, or any other computer system and/or computing platform.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An input control device, comprising:
a contact surface separated into a plurality of contact areas;
one or more input sensors disposed adjacent to each contact area and configured to receive user input therefrom; and
a controller operatively connected to the one or more input sensors and configured to determine a baseline locational arrangement of one or more input entities relative to one another and dynamically assign input sensors adjacent to the one or more input entities to receive input based on the baseline locational arrangement.

2. The input control device of claim 1, wherein the controller is further configured to determine a baseline orientation of the input control device, and wherein the baseline locational arrangement and the baseline orientation define a baseline operational condition of the input control device.

3. The input control device of claim 2, wherein the controller is further configured to provide a control instruction based on a difference between the baseline operational condition of the input control device and at least one of contact information corresponding to a disposition of the one or more input entities adjacent to the contact surface and an orientation of the input control device.

4. The input control device of claim 3, wherein the one or more input entities correspond to digits of a hand of a user, and wherein the baseline locational arrangement corresponds to measured distances between portions of the digits of the hand contacting the input control device.

5. The input control device of claim 4, wherein the baseline locational arrangement defines which individual digits of the hand are allowed to provide input to the input control device.

6. The input control device of claim 4, wherein upon moving the input control device relative to the hand of the user such that the digits contact other input sensors of the one or more input sensors, the controller is further configured to dynamically assign the other contacted input sensors adjacent to the digits to receive input based on the baseline locational arrangement.

7. The input control device of claim 4, wherein the control instruction is at least partially based on the difference between the baseline orientation and a changed orientation of the input control device, wherein the changed orientation of the input control device corresponds to at least one of a pitch, a roll, and a yaw of the input control device.

8. The input control device of claim 4, further comprising:
one or more orientation sensors configured to provide at least one of the baseline orientation of the input control device and a changed orientation of the input control device based on a measurement of a device reference relative to a gravity vector reference.

9. The input control device of claim 4, wherein the one or more input sensors include at least one of a pressure sensor, piezoelectric sensor or transducer, capacitive sensor, potentiometric transducer, inductive pressure transducer, strain gauge, displacement transducer, resistive touch surface, capacitive touch surface, image sensor, camera, temperature sensor, and IR sensor.

10. The input control device of claim 4, wherein the input control device is configured as a substantially ellipsoidal or ovoid shape.

11. The input control device of claim 4, further comprising:
a communications module configured to provide the control instruction to a computer system communicatively connected to the input control device.

12. The input control device of claim 4, wherein the control instruction is based at least partially on a pressure associated with one or more digits contacting a particular contact area of the input control device.

13. A method of configuring an input control device, comprising:
determining a baseline locational arrangement of one or more input entities relative to one another based on information provided via one or more input sensors of the input control device; and
assigning, dynamically and in response to determining the baseline locational arrangement, input sensors adjacent to the one or more input entities to receive input based on the baseline locational arrangement.

14. The method of claim 13, further comprising:
determining a baseline orientation of the input control device, and wherein the baseline locational arrangement and the baseline orientation define a baseline operational condition of the input control device.

15. The method of claim 14, further comprising:
providing a control instruction based on a difference between the baseline operational condition of the input control device and at least one of contact information corresponding to a disposition of the one or more input entities adjacent to the contact surface and an orientation of the input control device.

16. The method of claim 15, wherein prior to providing the control instruction, the method further comprises:
determining which individual entities of the one or more entities are allowed to provide input to the input control device.

17. The method of claim 13, further comprising:
initiating an operational timer upon receiving a contact from the one or more input entities, wherein the operational timer includes an expiration value;
determining whether the operational timer has expired; and
reducing a power consumption of the input control device when the operational timer has expired.

18. The method of claim 13, wherein the one or more input entities correspond to digits of a hand of the user, and wherein the baseline locational arrangement corresponds to measured distances between contacting portions of the digits of the hand.

19. The method of claim 18, wherein upon moving the input control device relative to the hand of the user such that the digits contact other input sensors of the one or more input sensors, the method further comprises:
dynamically assigning the other contacted input sensors adjacent to the digits to receive input based on the baseline locational arrangement.

20. A computer control system, comprising:
an input control device, comprising:
a nonplanar contact surface having a plurality of contact areas;
one or more input sensors disposed adjacent to each contact area, the one or more input sensors having an unassigned input functionality; and
a controller operatively connected to the one or more input sensors and configured to determine a baseline locational arrangement of one or more input entities relative to one another and dynamically assign an input functionality to input sensors adjacent to the one or more input entities such that the one or more input sensors are configured to receive input based on the baseline locational arrangement; and
a computer system having at least one of an audio, a video, and a haptic output, wherein the computer system is configured to receive input provided via the input sensors adjacent to the one or more input entities and translate the input provided to the at least one of the audio, the video, and the haptic output.
